(19) United States
(12) Patent Application Publication
(10) Pub. No.: US 2025/0198852 A1
(43) Pub. Date: Jun. 19, 2025

(54) THERMAL SENSOR SYSTEM

(71) Applicant: Transportation IP Holdings, LLC, Norwalk, CT (US)

(72) Inventor: Ajith Kuttannair Kumar, Ashburn, VA (US)

(73) Assignee: Transportation IP Holdings, LLC, Norwalk, CT (US)

(21) Appl. No.: 18/986,302

(22) Filed: Dec. 18, 2024

Related U.S. Application Data
(60) Provisional application No. 63/611,617, filed on Dec. 18, 2023.

(51) Int. Cl. G01K 3/00; G01K 1/024; G01K 1/14; G01K 11/32; H01M 10/48

(52) U.S. Cl. CPC G01K 3/005; G01K 1/024; G01K 1/14; G01K 11/32; H01M 10/482; H01M 10/486; H01M 2220/20

(57) ABSTRACT

In a sensor system and a method, an elongated sensor extends along or between different locations within a sensed system. The elongated sensor generates an electrical short between conductors within the elongated sensor or changes an attenuation of light propagating through the elongated sensor responsive to a change in temperature in one or more of the different locations exceeding a determined temperature value.

### CROSS-REFERENCE TO RELATED APPLICATIONS

This application claims benefit under 35 U.S.C. § 119 (e) to U.S. Provisional Application No. 63/611,617, filed Dec. 18, 2023, entitled “THERMAL SENSOR SYSTEM,” the entire disclosure of which is hereby incorporated by reference herein.

### BACKGROUND

### Technical Field

The disclosure pertains to a system and a method for detecting a temperature, with a particular focus on monitoring a sensor for an electrical short and an attenuation of light.

### Discussion of Art.

Some powered systems have energy storage systems held inside enclosures. For example, in a large battery powered vehicle such as an off-highway vehicle or a locomotive, there are many batteries enclosed inside. These enclosures have exhaust ports connected with each other via an exhaust chimney. These ports and chimney direct exhaust flow from the energy storage systems. Optionally, powered systems that rely on fuel cells have exhaust ports and chimneys to direct heat away from the fuel cells and/or other components.

These energy storage systems experience a thermal runaway event. Early detection of these events is helpful in containing damage to the energy storage systems and the powered system. Currently, identification of an event is performed inside the enclosures using potentially complex layering of sensors, software, controllers, and communications. Electronic sensors inside the enclosures monitor temperatures in the enclosures. These temperatures are communicated as data signals to a battery management system. This system operates using software that examines the signals, determines whether the signals indicate a thermal runaway event is occurring, and sends a notification to multiple battery pack management controllers. These controllers then send a signal to a control computer, which generates and communicates a signal activating a cooling system to cool the energy storage system(s) involved in the thermal runaway event. These many layers of detection, signal generation, signal communication, and the like, introduce many opportunities for error or missed detection of a thermal runaway event.

Locations inside the chimneys, exhaust ports, and the like are difficult to reach for installation and/or maintenance of sensors. Some systems have thermocouples positioned near the tops of the chimneys, which are easier to reach. These thermocouples actuate a relay responsive to detecting a thermal runaway event. The actuated relay turns on a cooling system to cool the energy storage devices associated with the thermal runaway event. It is difficult to know, however, whether these thermocouples are operating properly. This requires manual testing of each thermocouple to ensure that all thermocouples are operating properly (e.g., by exposing each thermocouple to a heat source, such as a blowtorch). Such manual testing is time consuming and prone to error. Additionally, these thermocouples only sense temperatures in one location each (e.g., at the top of each chimney). The thermocouples are unable to be located closer to the enclosures of the energy storage devices (due to the confined space preventing the testing of the thermocouples). It is desirable to have a system and method that differs from those that are currently available.

### BRIEF DESCRIPTION

In one or more embodiments, a sensor system is provided. The sensor system includes an elongated sensor. The elongated sensor extends along or between different locations within a sensed system. The elongated sensor generates an electrical short between conductors within the elongated sensor responsive to a change in temperature in one or more of the different locations exceeding a determined temperature value. The elongated sensor changes an attenuation of light propagating through the elongated sensor responsive to the change in temperature in the one or more of the different locations exceeding the determined temperature value.

In one or more embodiments, a sensor system is provided. The sensor system includes a linear sensor. The linear sensor continuously extends along or between energy storage devices within a powered system. The linear sensor detects a temperature within the powered system exceeding a detection temperature limit at any location along a length of the linear sensor by one or more of generating an electrical short within the linear sensor and changing an attenuation of light propagating through the linear sensor.

In one or more embodiments, a method is provided. The method includes: threading an elongated continuous sensor through locations of energy storage devices within a vehicle; coupling opposite ends of the elongated continuous sensor with galvanically isolated connectors; and coupling the galvanically isolated connectors with a controller configured to monitor the elongated continuous sensor for one or more of an electrical short within the elongated continuous sensor and a change in an attenuation of light within the elongated continuous sensor that indicates that a temperature within the vehicle exceeds a temperature limit.

### BRIEF DESCRIPTION OF THE DRAWINGS

FIG. 1 illustrates a schematic diagram of a sensed system according to one embodiment.

FIG. 2 illustrates a schematic diagram of a sensor system according to one embodiment.

FIG. 3 illustrates a schematic diagram of a sensor of a sensor system according to one embodiment.

FIG. 4 illustrates a schematic diagram of a sensor system according to one embodiment.

FIG. 5 illustrates a flowchart of a method according to one embodiment.

FIG. 6 illustrates a flowchart of a method according to one embodiment.

### DETAILED DESCRIPTION

Embodiments of the subject matter described herein relate to sensor systems and methods or thermal sensor systems and methods that can use elongated sensors that extend along or between multiple, different locations within a sensed system. For example, the sensors may be flexible linear cables that can be bent or threaded through different ports, chimneys, channels, conduits, or other locations within a powered vehicle having energy storage devices. The sensors can generate an electrical short between conductors within the sensors responsive to a change in temperature at or near the sensors exceeding a determined temperature value. For example, heat caused by a thermal runaway event of a battery may melt a dielectric sheath around at least one conductor. This can allow the conductors in the sensor to contact each other and be electrically shorted together. The electrical short can be used to detect the thermal runaway event. Optionally, the sensor may include a fiber optic cable. Heat caused by the thermal runaway event can change the attenuation of light passing through the cable. This also can be used to detect the thermal runaway event. Because the conductors may be galvanically isolated from the energy storage devices, the conductors may have fewer failure modes than sensors that are not galvanically isolated.

The sensor can be elongated and be placed along or between multiple different locations of gas exhausts of the energy storage devices. This can allow the sensor to be in positions where heated exhausts may flow just before or during the beginning of a thermal runaway event. The sensor can extend along or near each of the energy storage devices, along or near each of several groups of the energy storage devices (e.g., the enclosure holding several batteries), or along or near an enclosure holding all the energy storage devices. The sensor may be able to detect the elevated temperature at any location along the length of the sensor that is exposed and not included in a connector or connection to a controller or other device.

The sensor may provide a binary output or a location specific output. The binary output may indicate that the elevated temperature was detected without identifying the specific location where the elevated temperature was detected. The location specific output may indicate the location where the elevated temperature was detected.

Detection of the elevated temperature can be reported from the sensor to a controller that can implement one or more responsive actions. For example, the energy storage device(s) may be shut down, a fire suppression system may be activated, the sensed system (e.g., vehicle) may be deactivated, a warning to the operator of the sensed system may be generated, or the like.

The sensor systems can operate independent of other controls of the sensed system. For example, the sensor systems may operate on their own and without a vehicle controller, a communication device of the vehicle, or the like, required to be activated to operate the sensor systems. Optionally, the sensor systems can be controlled by the other controls of the sensed system. For example, the vehicle controller can repeatedly test operation of the sensor system and/or monitor operation of the sensor system, as described herein.

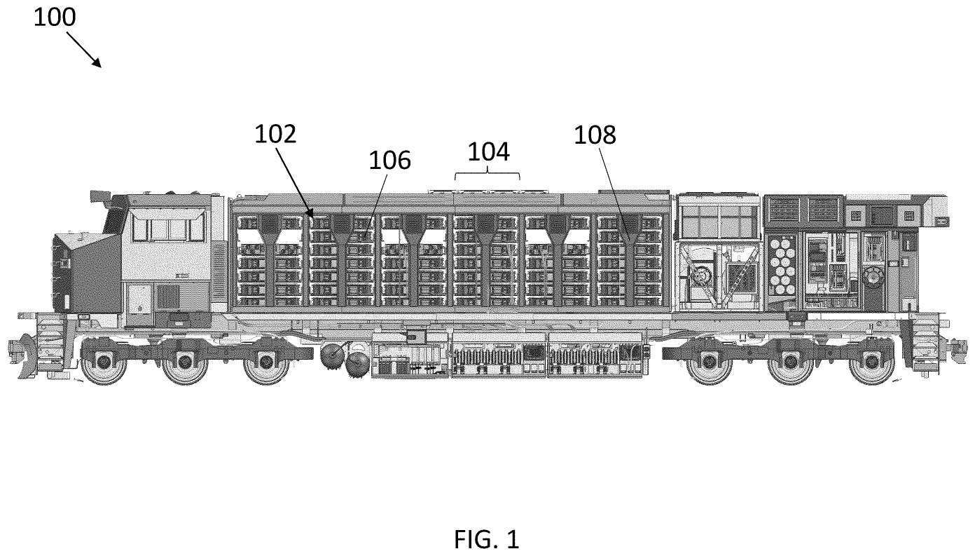

In one embodiment, FIG. 1 illustrates a sensed system 100. The sensed system may include one or more loads that are at least partially powered by energy storage devices 102. In one embodiment, the sensed system is a vehicle (e.g., a locomotive) and the loads can be traction motors, electrically controlled pneumatic brakes, communication devices, displays, etc. Alternatively, the sensed system may not be a vehicle and/or may include other loads that are electrically powered to perform other work. The sensed system may be referred to as or related to a powered system.

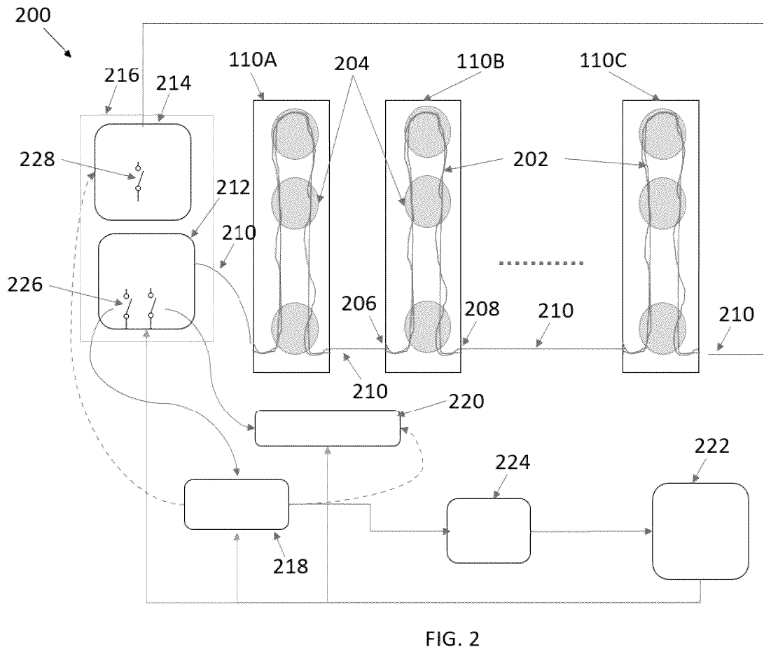

Suitable energy storage devices can include batteries, battery cells, capacitors, and the like. Fuel cells are to be included in term energy storage device for simplicity, even though a fuel cell's energy is stored as fuel rather than electrical potential. Suitable energy storage devices may be connected together in series and/or parallel, in groups or modules 104. The energy storage devices or the groups may be stored in enclosures or housings 106. These enclosures or housings may have exhaust ports (such as exhaust ports 204 shown in FIG. 2) that are fluidly coupled with chimneys 108 that direct exhaust from the containers or housings out of the powered system. This exhaust can be moved by a ventilation system that vents exhaust gases out of the powered system. These gases may build up in or around the energy storage devices without this ventilation.

In one embodiment, FIG. 2 schematically illustrates a sensor system or a thermal sensor system 200. The sensor system may include one or more elongated sensors 202. These elongated sensors may be flexible cables capable of being bent or bending around corners to extend through various passageways leading to and/or from the enclosures of the energy storage devices. For example, one elongated sensor may extend upward in a first chimney 110A of the powered system past and/or into several exhaust ports 204 of the enclosures of the energy storage devices. This same sensor may bend within the first chimney and extend down the first chimney past and/or into the same exhaust ports. Another one of the elongated sensors may similarly extend upward in a second chimney 110B, include a bend, and extend downward in the second chimney. One or more additional elongated sensors may similarly extend and/or bend within one or more additional chimneys 110C, as shown in FIG. 2. Each elongated sensor may extend from one end 206 to an opposite end 208. Each of these ends may be connected to a cable 210 so that the sensors are connected in series. Optionally, two or more of the sensors can be connected in parallel to each other.

The cables that connect the ends of the sensors can be conductive cables. At least one cable can connect the end of the sensor in the first chimney to a detection device 212. Another cable can connect the end of the sensor in the last chimney to a verification device 214. The detection and verification devices can be included in or coupled with a sensor controller 216. The detection device, the verification device, and the sensor controller can represent hardware circuitry that includes and/or is connected with one or more processors, such as one or more microprocessors, field programmable gate arrays, integrated circuits, or the like, that perform the operations described in connection with the corresponding device or controller.

The sensor controller may be connected via wired and/or wireless communication pathways to other components of the powered system, such as a system controller 218 and a thermal management system (TMS) 220 (as shown in FIG. 2). As described herein, the detection device can be used to detect thermal events, the verification device can be used to test operation of the sensors and the sensor system, and the sensor controller can communicate with the system controller and/or the thermal management system in response to detection of a thermal event.

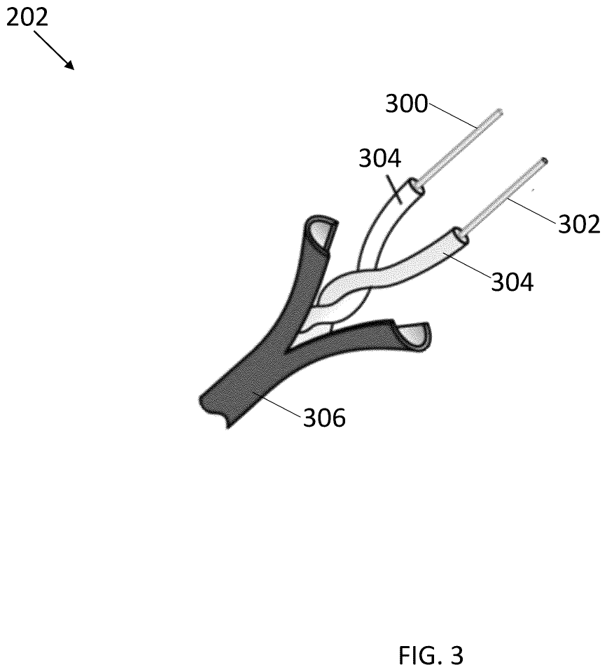

In one embodiment, FIG. 3 illustrates a cutaway drawing of the elongated sensor shown in FIG. 2. The elongated sensor may include two or more elongated conductors 300, 302 that extend the length of the sensor. Each of these conductors may be separately enclosed in a dielectric inner sheath or jacket 304. Suitable sheaths, jackets or coatings may be non-conductive (e.g., plastic) such that the coating may prevent the conductors from physically contacting each other and may provide sufficient insulation to reduce the chance of forming an electrical short. A dielectric outer sheath or jacket 306 may be disposed around the sheaths or jackets containing the conductors. Ends of the conductors may be exposed (but not contact each other) to conductively couple each conductor with different conductors in the same cable or with conductors in different cables. Optionally, one or more other layers may be disposed between the inner and outer sheaths. For example, a layer of polyester tape may be wrapped around the inner sheaths inside the outer sheath.

Suitable polymers used to form the inner sheaths may be heat sensitive polymers that change phases (e.g., melt) responsive to being exposed to a specified temperature. This melting can create an electric short between the conductors by allowing the conductors to contact each other. This, in turn, can be used to identify a thermal event. Several sensors may be used to extend through the powered system with different sensors having inner sheaths with polymers that melt at different temperatures. For example, one sensor may melt and form a short responsive to being exposed to, not limited to, 57 degrees Celsius (134.6 degrees Fahrenheit), another sensor may melt and form a short responsive to being exposed to, not limited to, 88 degrees Celsius (190.4 degrees Fahrenheit), and so on. This can provide the sensor system with the ability to detect different thermal events at different temperatures. For example, a short may be detected in one sensor but not another sensor. This can indicate that the temperature to which the sensors were exposed is at least, not limited to, 57 degrees Celsius (134.6 degrees Fahrenheit), but cooler than, not limited to, 88 degrees Celsius (190.4 degrees Fahrenheit). Additional sensors can be used with different heat sensitive polymers as the inner sheaths to provide further granularity in detecting different temperatures.

Positive temperature coefficient (PTC) materials may be used to mitigate the effect of electrical shorts in some embodiments. In other embodiments, the coating (or sheath) is selected to be electrically insulative but thermally conductive. In such an application, the heat is not distributed along a length of the sensor but rather translates directly to the fiber or a coating layer adjacent to the fiber. This can aid in localizing the heat source more precisely, should that be desirable to the end use application.

Returning to the description of the sensor system shown in FIG. 2, the conductors in the sensors may be galvanically isolated from the energy storage devices. The conductors may not be conductively coupled with the high voltages stored in the energy storage devices. Instead, a lower voltage (74 volts or less as one example) can be conducted in at least one of the conductors from a control battery 222. The detection device can monitor one or more of the conductors in the sensors via the cables that connect these conductors. The detection device can identify a short or contact between these conductors based on conduction of the voltage. Responsive to identifying the short, the detection device can determine that the temperature to which the sensor(s) was exposed exceeded an upper detection temperature or limit, or a detection temperature limit. This can indicate a thermal event, such as thermal runaway of one or more of the energy storage devices.

Responsive to detecting the thermal event, the detection device can implement one or more responsive actions. For example, the detection device can activate the thermal management system. The thermal management system can include a fire suppression system. In one embodiment, the system can automatically spray fire suppression material. Suitable fire suppression material may include liquid (e.g., water, foam), gas (e.g., nitrogen, carbon dioxide), or other chemicals (e.g., halon, potassium acetate, sodium carbonate) toward the energy storage device, to the source of the fire, into the chimney or vent, or to the air intake. Activation of the fire suppression system may suppress, reduce, prevent, or extinguish a fire. The thermal management system can include a cooling system that directs a coolant toward the energy storage devices to cool the temperature(s) of the energy storage devices. For example, the cooling system may activate fans or pumps that move a working fluid (e.g., air or a liquid) across or near the energy storage devices to cool the energy storage devices. As another example, the detection device can send a signal to the system controller to deactivate the energy storage devices (e.g., by opening a circuit connecting the energy storage devices with the loads), to stop charging the energy storage devices (e.g., by opening switches between the energy storage devices and a power source), to generate a warning for an operator of the powered system, or the like. The detection device may select which responsive action to implement based on which of several different sensors indicated a short. For example, different sensors may indicate a short when exposed to different temperatures. The detection device may implement different responsive actions based on which sensor indicated the short.

In one embodiment, the detection device can include switches 226 that close responsive to detecting the short between the conductors in the sensor(s). Closing these switches can conduct a signal to a corresponding device (e.g., the thermal management system, the vehicle controller, etc.) to actuate the device as described above.

The sensor system or the sensed system may include a control battery charger 224 that can charge the control battery (also referred to as or related to the control energy storage device). This charger may include a cable to connect a utility power grid, a pantograph, an electrified rail, an alternator or generator, or the like, to the control battery for charging the control battery. Responsive to a thermal event being detected, the detection device can automatically activate the thermal management system to direct coolant toward and/or over the energy storage devices being monitored by the sensor(s). The control battery can power the thermal management system (e.g., the fans and/or pumps) without having to rely on activation of the sensed system. This can ensure that the sensor system can operate without reliance on operation of the sensed system and without drawing power from the energy storage devices that are monitored.

The verification device can include a switch 228 that is connected to and disposed between the conductors in the sensor(s). This switch can be manually or automatically closed to generate a short between the conductors in the sensor(s) but without the inner sheaths in the sensor(s) melting or changing phase. This can be done to test the sensor(s) and the detection device and ensure that the sensor system and related actions are operating properly. The automatic verification can be repeatedly initiated (e.g., once per day, once per trip, etc.). Manual verification can be performed whenever maintenance is performed or during inspection (e.g., repeated inspection, such as once every six months).

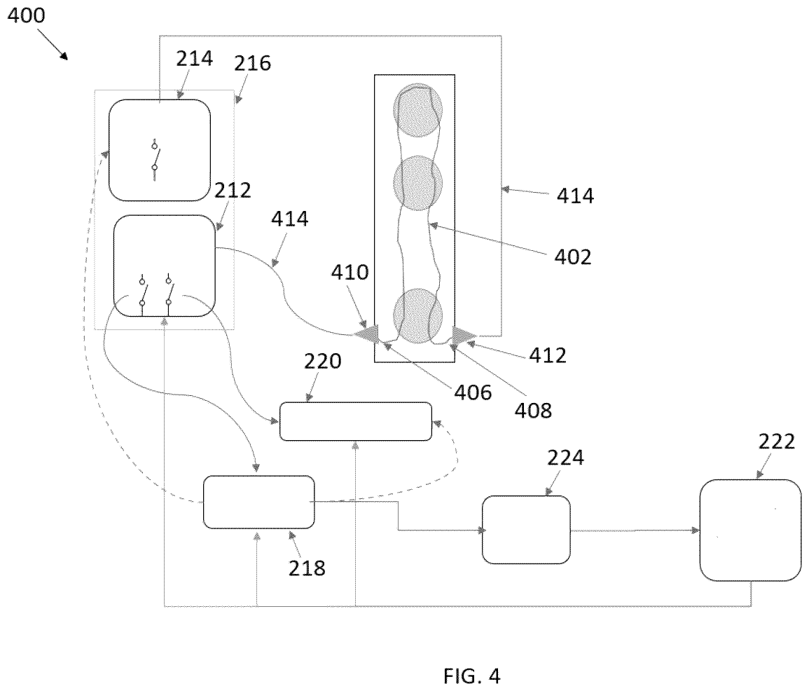

In one embodiment, FIG. 4 schematically illustrates a sensor system or a thermal sensor system 400 similar to that in FIG. 2. The sensor system may include one or more elongated sensors 402. These elongated sensors may be flexible cables capable of being bent or bending around corners to extend through various passageways leading to and/or from the enclosures of the energy storage devices, similar to the sensors shown in FIG. 2. While only one sensor and chimney are shown in FIG. 4, the powered system may include more chimneys and the sensor system may include more than one sensor.

The sensor may include a fiber optic cable that transmits light, e.g., laser light, along the length of the sensor. The sensor may extend from one end 406 to an opposite end 408. One of these ends may be connected to an optical transmitter 410 and the other end may be connected to an optical receiver 412. The optical transmitter may generate light of one or more wavelengths for transmission via the fiber optic cable. The optical receiver can include a photosensitive diode or other device that senses receipt of the light from the transmitter via the fiber optic cable.

Cables 414 can connect the optical transmitter and the optical receiver with the sensor controller. The sensor controller can send signals to the optical transmitter via the cable(s) to direct the optical transmitter to generate light into the fiber optic cable of the sensor. The sensor controller can receive signals from the optical receiver via the cable(s) to measure the magnitude or intensity of the light received by the optical receiver. If several sensors are provided, each sensor may have a separate optical transmitter and a separate optical receiver than the other sensors, with each optical transmitter and optical receiver connected with the sensor controller by cables. These sensors may be in different chimneys (e.g., one sensor in each chimney) or two or more of the sensors may be in the same chimney.

The fiber optic cable in the sensor may be galvanically isolated from the energy storage devices. The fiber optic cable may be non-conductive such that the fiber optic cable is not conductively coupled with the high voltages stored in the energy storage devices.

The fiber optic cables in the sensors may be formed from flexible glass or plastic fiber. Different glasses or plastics may be used in different sensors, with temperature changing how the glasses or plastics attenuate light by different amounts. For example, one sensor may include optical fibers formed from a first glass or first plastic that reduces the intensity or magnitude of light propagating through the optical fibers by a first amount when exposed to a temperature. Another sensor may include optical fibers formed from a different second glass or a different second plastic that reduces the intensity or magnitude of light propagating through the optical fibers by a greater, second amount when exposed to the same temperature. Other sensors may attenuate light by different amounts when exposed to the same temperature. The different attenuation of light by different sensors can allow the detection device to estimate or determine the temperature to which the sensors are exposed. For example, the detection device can examine the intensities of light that propagated through (or was blocked by) the optical fibers in different sensors. Different attenuations of light (or different magnitudes or intensities of light received by the optical receivers) may be associated with different temperatures. The detection device can use these associations to determine or estimate the temperature within a chimney or other area.

The optical fibers within one or more of the sensors may be enclosed in a sheath, similar to the inner or outer sheaths described above in connection with the sensors having the conductors. The sheath around the optical fibers in a sensor may be formed from temperature sensitive polymers. These polymers may change shape responsive to being exposed to different temperatures. For example, the polymer sheath of a sensor may bend or curve by different distances or to different angles in proportion to the temperature to which the sheath is exposed. The sheath may bend a first distance responsive to being exposed to a first temperature but may bend a greater second distance responsive to being exposed to a warmer second temperature. The distance by which the sheath bends can attenuate the transmission of light through the optical fibers in the sensor by different amounts. Different attenuations of the light can be associated by the detection device with different temperatures. The detection device can estimate or determine a temperature to which the sensor is exposed based on the attenuation of the light as detected by the optical receiver coupled to the sensor using these associations between attenuations of light and temperatures.

The sensors optionally can be used to detect a location along the length of the sensor where the sensor was exposed to an elevated temperature (warmer than a temperature threshold or limit indicative of a thermal event). For example, exposure of a leading location in the sensor to the elevated temperature may attenuate light differently (e.g., more) than exposure of a middle location or trailing location in the sensor. The leading location may be closer to the optical transmitter, the trailing location may be closer to the optical receiver, and the middle location may be between the leading location and the trailing location (or closer to the center or midpoint of the sensor along the length of the sensor than to the optical transmitter or the optical receiver). Exposure of the middle location in the sensor to the elevated temperature may attenuate light differently than exposure of the leading or trailing locations in the sensor. Exposure of the trailing location in the sensor to the elevated temperature may attenuate light differently than exposure of the leading or middle locations in the sensor. The different attenuations of light may be associated with different locations along the length of the sensor. The detection device can examine the light received by the optical receiver and identify the location where the sensor was exposed to the elevated temperature using these associations.

Responsive to detecting the thermal event, the detection device can implement one or more responsive actions, as described above. The verification device can include the switch that is connected to the optical transmitter and/or optical receiver of a sensor. This switch can be manually or automatically actuated to stop the optical transmitter from generating light, to stop or block signals from the optical receiver, or to both stop the optical receiver from generating light and stop/block signals from the optical receiver. The detection device can then detect the complete attenuation or blockage of light and determine that the sensor was exposed to an elevated temperature. This process can be used to test operation of the sensor(s) and the detection device and ensure that the sensor system is operating properly.

The different associations between temperatures, locations, attenuations of light, different sensors that create a short at different temperatures, etc. described herein may be stored in a tangible and non-transitory computer readable storage medium. This medium can be a computer hard drive, solid state drive, optical disc, flash drive, register memory, read-only memory, random-access memory, or the like. The storage medium can be included in the detection device, the system controller, the sensor controller, or can be a separate component of the sensor system.

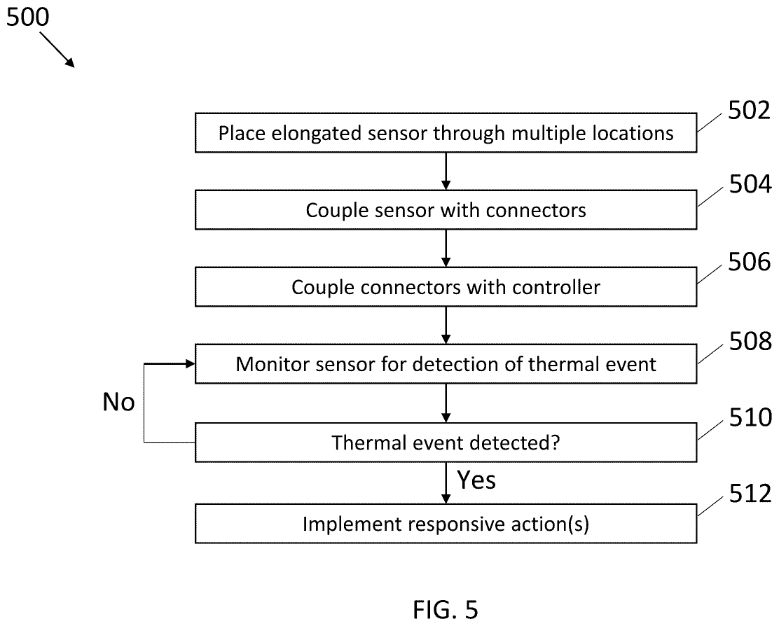

In one embodiment, FIG. 5 illustrates a flowchart of a method 500 for monitoring temperatures of a sensed system. The method can be practiced by one or more examples of the sensor system described herein. In one embodiment, the method includes steps of: threading 502 an elongated continuous sensor through locations of energy storage devices within a vehicle; coupling 504 opposite ends of the elongated continuous sensor with galvanically isolated connectors; coupling 506 the galvanically isolated connectors with a controller configured to monitor 508 the elongated continuous sensor for one or more of an electrical short within the elongated continuous sensor and a change in an attenuation of light within the elongated continuous sensor that indicates that a temperature within the vehicle exceeds a temperature limit.

At the step 502, an elongated sensor may be placed through multiple locations in the sensed system. For example, the elongated, continuous sensors described herein may be threaded through multiple locations in or around enclosures of energy storage devices, exhaust ports of the energy storage devices, chimneys connected to the exhaust ports, etc. Optionally, the sensors may be placed elsewhere where a thermal event is to be detected. The sensors may be continuous in that the sensors can have the ability to sense a thermal event at any location that is exposed to temperatures along the length of the sensors.

At the step 504, the sensor is coupled with connectors. Each sensor may have opposite ends, and these ends can be connected with connectors that conductively couple the ends of the sensor with cables, other sensors, the detection device, and/or the verification device. Optionally, the ends of each sensor may be connected with an optical transmitter and an optical receiver as connectors. The sensors and the connectors may be galvanically isolated from the energy storage devices, as described above.

At the step 506, the connectors may be coupled with a controller. The connectors can be connected with a sensor controller. Cables may conductively couple the connectors of the sensor with the verification device and/or detection device of the sensor controller.

At the step 508, the sensor is monitored for detection of a thermal event. For example, the detection device may monitor the sensor for detection of an electric short or for attenuation of light. The short and/or attenuation of light can indicate that the sensor has been exposed to an elevated temperature associated with a thermal event at some location along the length of the sensor.

In one embodiment, the method further includes steps of: determining 510 whether a thermal event is detected; implementing 512 one or more actions responsive to a determination that the thermal event is detected; and monitoring the elongated continuous sensor responsive to a determination that the thermal event is not detected.

At the step 510, a decision is made as to whether a thermal event is detected. The sensor can indicate that a thermal event has occurred by creating a short between the conductors in the sensor or by attenuating light propagating through the sensor. If a short is detected or the light is attenuated by at least a threshold amount, then this short or amount of attenuation can indicate that the sensor was exposed to an undesirably hot temperature. As a result, flow of the method can proceed toward the step 512. Otherwise, flow of the method can return to a prior operation, such as the step 506.

At the step 512, one or more responsive actions are implemented. These actions may be implemented responsive to detection of the thermal event to end the thermal event, protect the sensed system, and/or protect occupants of the sensed system. For example, the sensor controller can notify the system controller, can activate the thermal suppression system, can open circuits to disconnect the energy storage devices from the loads and/or power sources, or the like. Flow of the method can terminate or return to one or more prior steps.

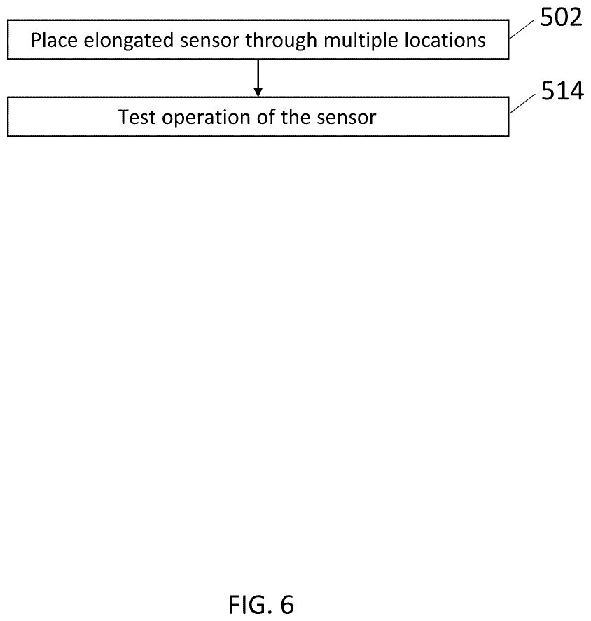

In one embodiment, as shown in FIG. 6, the method further includes steps of testing 514 operation of the elongated continuous sensor by connecting the galvanically isolated conductors within the elongated continuous sensor with each other or by changing the attenuation of light through a fiber optic cable within the elongated continuous sensor.

Light attenuation in a fiber optic strand may occur from pressure and/or bending, rather than or in addition to temperature. A heat reactive coating around a fiber optic bundle may respond to increasing temperature by swelling. In another embodiment, the coating may be formed from plural materials having different Coefficients of Thermal Expansion (CTE), and as such the application of heat to the coating may cause it to twist and/or bend in a determined manner. This may be used, depending on the application, as a binary on/off approach where a threshold level of pressure of bending is met at a determined temperature-thus being useful to affect the light attempting to travel through the fiber. In an alternative embodiment, the temperature creates a proportionate level of bend, twist or pressure and the level of distortion in the traveling light is both proportional and measurable.

In one embodiment, the time of flight of the light through the fiber optic may be used to determine how far along the length of the cable the distortion is occurring, which is thus an indication of where the heat is being applied to the fiber optic.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

With respect to energy sources that can provide electric energy (e.g., direct and/or alternating current) to one or more loads, the energy sources may include one or more fuel cells. Suitable fuel cells may include a solid oxide fuel cell (SOFC), a proton exchange membrane (PEM) fuel cell, an alkaline fuel cell, direct methanol, fuel cell, molten carbonate fuel cell, and an acid fuel cell. Suitable acid fuel cells may include solid acid and phosphoric acid fuel cells. Examples of suitable fuel cell electrodes may include a catalyst containing platinum and ruthenium; or a catalyst containing titanium tungsten oxide nanoparticles that are coated with a layer of platinum. A suitable polymer membrane may be Nafion, which is commercially available from Du Pont, or expanded porous polytetrafluoroethylene (ePTFE).

If a system, apparatus, assembly, device, etc. (e.g., a controller, control device, control unit, etc.) includes multiple processors, these processors may be located in the same housing or enclosure (e.g., in the same device) or may be distributed among or between two or more housings or enclosures (e.g., in different devices). The multiple processors in the same or different devices may each perform the same functions described herein, or the multiple processors in the same or different devices may share performance of the functions described herein. For example, different processors may perform different sets or groups of the functions described herein.

In one embodiment, the sensor system may have a local data collection system deployed that may use machine learning to enable derivation-based learning outcomes. The sensor controller may learn from and make decisions on a set of data (including data provided by the sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the sensor system may include a policy engine that may apply one or more policies. These policies may be based at least in part on characteristics of a given item of equipment or environment. With respect to control policies, a neural network can receive input of a number of environmental and task-related parameters. These parameters may include detection of electric shorts in sensors, different amounts of attenuation of light, or the like. The neural network can be trained to generate an output based on these inputs, with the output representing an action or sequence of actions that the sensor controller should take. During operation of one embodiment, a determination can occur by processing the inputs through the parameters of the neural network to generate a value at the output node designating that action as the desired action. This action may translate into a signal that causes the sensor controller to operate. This may be accomplished via back-propagation, feed forward processes, closed loop feedback, or open loop feedback. Alternatively, rather than using backpropagation, the machine learning system of the sensor controller may use evolution strategies techniques to tune various parameters of the artificial neural network. The sensor controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The sensor controller can use this artificial intelligence or machine learning to receive input (e.g., detection of a short or light attenuation), use a model that associates different detections of shorts or different amounts of light attenuation with different temperatures or with different responsive actions. The sensor controller can then provide an output (e.g., the selected responsive action(s) or the selected temperature). The sensor controller may receive additional input, such feedback on whether a thermal event actually occurred, whether the responsive action was sufficient to terminate the thermal event, whether the selected temperature is accurate, or the like. Based on this additional input, the sensor controller can change the model, such as by changing which responsive action or temperature would be selected when a similar or identical input is received the next time or iteration. The sensor controller can then use the changed or updated model again to select the action or temperature, receive feedback on the selected action or temperature, change or update the model again, etc., in additional iterations to repeatedly improve or change the model using artificial intelligence or machine learning.

A sensor system may include an elongated sensor that can extend along or between multiple, different locations within a sensed system. The elongated sensor can generate an electrical short between conductors within the elongated sensor and/or change an attenuation of light propagating through the elongated sensor responsive to a change in temperature in one or more of the different locations exceeding a determined temperature value.

The elongated sensor may include the conductors, and the elongated sensor can extend along or between the multiple, different locations of gas exhausts of energy storage devices. The conductors in the elongated sensor may be galvanically isolated from the energy storage devices. The elongated sensor can detect the change in temperature for each of the energy storage devices, each group of several groups of the energy storage devices, and/or all the energy storage devices.

The elongated sensor can include the conductors disposed within and separated from each other by one or more insulative sheaths that change a characteristic to generate the electrical short between the conductors responsive to the change in temperature. This characteristic may be a phase of the sheaths, a shape or amount of bend of the sheaths, or the like.

The elongated sensor can include a fiber optic cable that changes the attenuation of light propagating through the fiber optic cable responsive to the change in temperature. The fiber optic cable can have a temperature sensitive sheath that bends the fiber optic cable in proportion to temperature. The sensor system also can include a sensor controller coupled with the elongated sensor. The sensor controller can determine where along a length of the fiber optic cable that the change in temperature is occurring.

The sensor controller can respond to detection of the change in temperature along a length of the elongated sensor that is greater than a determined threshold temperature by switching a circuit from closed to open. The sensor controller can respond to detection of the change in temperature along a length of the sensor that is greater than a determined threshold temperature by activating a fire suppression system.

The sensor system also can include a verification device coupled with the elongated sensor. The verification device can connect the conductors in the elongated sensor with each other to generate the electrical short and/or change the attenuation of light propagating through the elongated sensor to test operability of the elongated sensor. The sensor system can include a detection device coupled with the elongated sensor to detect the electrical short and/or the change in the attenuation of light. The detection device can activate a thermal management system of the sensed system and/or generate a warning signal to an operator of the sensed system responsive to detecting the one or more of the electrical short or the change in the attenuation of light. The sensor system can include one or more additional second elongated sensors that may extend along or between the different locations within the sensed system. The additional second sensors can generate the electrical short between additional second conductors within the one or more additional second elongated sensors and/or change the attenuation of light propagating through the one or more additional second elongated sensors responsive to a different second change in temperature.

Another sensor system can include a linear sensor that may continuously extend along or between energy storage devices within a powered system. The linear sensor can detect a temperature within the powered system exceeding an upper temperature limit at any location along a length of the linear sensor by one or more of generating an electrical short within the linear sensor or changing light attenuation within the linear.

The linear sensor can extend through gas exhaust ports of the energy storage devices with the linear sensor being galvanically isolated from the energy storage devices. The linear sensor can detect the temperature in one or more different locations exceeding the upper detection temperature or falling below the lower detection temperature for each of the energy storage devices, each group of several groups of the energy storage devices, and/or all the energy storage devices. The linear sensor can include conductors disposed within and separated from each other by one or more insulative sheaths. The sheaths can change a characteristic to generate the electrical short between the conductors responsive to the temperature in one or more different locations exceeding the upper detection temperature. The linear sensor can include a fiber optic cable that changes the attenuation of light within the fiber optic cable responsive to the temperature in one or more different locations exceeding the upper detection temperature.

The sensor system also can include a verification device coupled with the linear sensor. The verification device can connect conductors in the linear sensor with each other to generate the electrical short and/or change the attenuation of light propagating through the linear sensor to test operability of the linear sensor. The sensor system can include a detection device coupled with the linear sensor to detect the electrical short and/or the change in the attenuation of light. The detection device can activate a thermal management system of the powered system and/or generate a warning signal to an operator of the powered system responsive to detecting the one or more of the electrical short or the change in the attenuation of light.

A method for monitoring a sensed system (e.g., a vehicle) for changes in temperature can include threading an elongated, continuous sensor through multiple locations of energy storage devices within a vehicle, coupling opposite ends of the sensor with galvanically isolated connectors, and coupling the galvanically isolated connectors with a controller that can monitor the sensor for one or more of an electrical short within the sensor or a change in light attenuation within the sensor that indicates that a temperature within the vehicle exceeds an upper temperature limit. Optionally, the method may include testing operation of the sensor by connecting conductors within the sensor with each other or by changing attenuation of light through a fiber optic cable within the sensor.

Embodiments may be described in connection with a rail vehicle system, such as a locomotive or switcher, or other types of vehicle systems, such as automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

Movement of a vehicle system may include propelling the vehicle forward or backward along a direction of travel, as well as slowing or stopping the vehicle. Movement further may include turning left or right, and increasing or decreasing elevation or depth. Movement further may include determining or setting a vehicle speed, changing a vehicle speed, and matching speeds and directions between vehicles in a vehicle group. Indirectly, movement of the vehicle may include ramping up (or down) power sources; and this may include energizing electrical circuits or buses, setting fuel flow rates, setting engine RPM rates, and the like.

The terms “control circuit” and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features can be stored in various types of memory. Suitable memory may include dynamic random-access memory (DRAM), flash memory, and/or cache. These instructions can be distributed over a network or via other computer-readable media. The term “non-transitory computer-readable medium” refers to any physical medium capable of storing or transmitting instructions or information that can be read by a machine. Examples of suitable media include RAM, ROM, EPROM, EEPROM, magnetic or optical media, flash memory, or even propagated signals such as carrier waves or infrared signals.

In some embodiments, the control circuit can utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

As mentioned above, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model or a good-enough model may be selected, and the control circuit can execute that plan to achieve the desired input data to mirror the predicted ‘best outcome’ scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. Raw data gathered by these sensors may feed into the control circuit, which in turn can respond to the input. The responses may include dynamically adjusting vehicle operations in response to real-time or near real-time changes in the environment or vehicle parameters; and, processing the data for further analysis. In certain embodiments, sensors may utilize various types of communication protocols (e.g., Bluetooth, ZigBee, Wi-Fi, or cellular networks) to share data with control systems both within the vehicle and to external data processing centers.

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A sensor system comprising:
an elongated sensor configured to extend along or between different locations within a sensed system, the elongated sensor configured to one or more of:
generate an electrical short between conductors within the elongated sensor responsive to a change in temperature in one or more of the different locations exceeding a determined temperature value; and
change an attenuation of light propagating through the elongated sensor responsive to the change in temperature in the one or more of the different locations exceeding the determined temperature value.

2. The sensor system of claim 1, wherein the elongated sensor comprises the conductors, the elongated sensor is further configured to:
extend along or between the different locations of gas exhausts of energy storage devices,
wherein the conductors in the elongated sensor are galvanically isolated from the energy storage devices.

3. The sensor system of claim 2, wherein the elongated sensor is further configured to:
detect the change in temperature for one or more of:
each of the energy storage devices;
each group of groups of the energy storage devices; and
all of the energy storage devices.

4. The sensor system of claim 1, wherein the elongated sensor comprises the conductors disposed within and separated from each other by one or more insulative sheaths that change a characteristic to generate the electrical short between the conductors responsive to the change in temperature.

5. The sensor system of claim 1, wherein the elongated sensor comprises a fiber optic cable that changes the attenuation of light propagating through the fiber optic cable responsive to the change in temperature.

6. The sensor system of claim 5, wherein the fiber optic cable comprises a temperature sensitive sheath that bends the fiber optic cable in proportion to temperature.

7. The sensor system of claim 5 further comprising:
a sensor controller coupled with the elongated sensor, the sensor controller configured to:
determine where along a length of the fiber optic cable that the change in temperature is occurring.

8. The sensor system of claim 1 further comprising:
a sensor controller coupled with the elongated sensor, the sensor controller configured to:
respond to detection of the change in temperature along a length of the elongated sensor that is greater than a determined threshold temperature by switching a circuit from closed to open.

9. The sensor system of claim 1 further comprising:
a sensor controller coupled with the elongated sensor, the sensor controller configured to:
respond to detection of the change in temperature along a length of the elongated sensor that is greater than a determined threshold temperature by activating a fire suppression system.

10. The sensor system of claim 1 further comprising:
a verification device coupled with the elongated sensor, the verification device configured to one or more of:
connect the conductors in the elongated sensor with each other to generate the electrical short; and
change the attenuation of light propagating through the elongated sensor to test operability of the elongated sensor.

11. The sensor system of claim 1 further comprising: a detection device coupled with the elongated sensor, the detection device configured to detect the one or more of:
the electrical short; and
the change in the attenuation of light,
wherein the detection device is further configured to one or more of:
activate a thermal management system of the sensed system responsive to detecting the one or more of the electrical short and the change in the attenuation of light; and
generate a warning signal to an operator of the sensed system responsive to detecting the one or more of the electrical short and the change in the attenuation of light.

12. The sensor system of claim 1, wherein the elongated sensor is a first elongated sensor, the electrical short is a first electrical short, the conductors are first conductors, the change in temperature is a first change in temperature, the attenuation of light is a first attenuation of light, the determined temperature value is a first determined temperature value, and the sensor system further comprises:
one or more second elongated sensors configured to extend along or between the different locations within the sensed system, the one or more second sensors configured to one or more of:
generate a second electrical short between second conductors within the one or more second elongated sensors responsive to a second change in temperature in the one or more of the different locations exceeding a second determined temperature value; and
change a second attenuation of light propagating through the one or more second elongated sensors responsive to the second change in temperature in the one or more of the different locations exceeding the second determined temperature value,
wherein the second change in temperature is different from the first change in temperature, and the second determined temperature value is different the first determined temperature value.

13. A sensor system comprising:
a linear sensor configured to continuously extend along or between energy storage devices within a powered system, the linear sensor configured to:
detect a temperature within the powered system exceeding a detection temperature limit at any location along a length of the linear sensor by one or more of:
generating an electrical short within the linear sensor; and
changing an attenuation of light propagating through the linear sensor.

14. The sensor system of claim 13, wherein the linear sensor is further configured to:
extend through gas exhaust ports of the energy storage devices with the linear sensor being galvanically isolated from the energy storage devices.

15. The sensor system of claim 13, wherein the linear sensor is further configured to:
detect the temperature in one or more different locations exceeding the detection temperature limit or falling below the detection temperature limit for one or more of:
each of the energy storage devices;
each group of groups of the energy storage devices; and
all of the energy storage devices.

16. The sensor system of claim 13, wherein the linear sensor comprises conductors disposed within and separated from each other by one or more insulative sheaths that change a characteristic to generate the electrical short between the conductors responsive to the temperature in one or more different locations exceeding the detection temperature limit.

17. The sensor system of claim 13, wherein the linear sensor comprises a fiber optic cable that changes the light attenuation within the fiber optic cable responsive to the temperature in one or more different locations exceeding the detection temperature limit.

18. The sensor system of claim 13 further comprising:
a verification device coupled with the linear sensor, the verification device configured to one or more of:
connect conductors in the linear sensor with each other to generate the electrical short; and
change the attenuation of light propagating through the linear sensor to test operability of the linear sensor.

19. The sensor system of claim 13 further comprising:
a detection device coupled with the linear sensor, the detection device configured to detect the one or more of:
the electrical short; and
a change in the light attenuation of light,
wherein the detection device is further configured to one or more of:
activate a thermal management system of the powered system responsive to detecting the one or more of the electrical short and the change in the attenuation of light; and
generate a warning signal to an operator of the powered system responsive to detecting the one or more of the electrical short and the change in the attenuation of light.

20. A method comprising:
threading an elongated continuous sensor through locations of energy storage devices within a vehicle;
coupling opposite ends of the elongated continuous sensor with galvanically isolated connectors; and
coupling the galvanically isolated connectors with a controller configured to monitor the elongated continuous sensor for one or more of an electrical short within the elongated continuous sensor and a change in an attenuation of light within the elongated continuous sensor that indicates that a temperature within the vehicle exceeds a temperature limit.

21. The method of claim 19 further comprising:
testing operation of the elongated continuous sensor by connecting the galvanically isolated conductors within the elongated continuous sensor with each other or by changing the attenuation of light through a fiber optic cable within the elongated continuous sensor.
